(19) United States
(12) Patent Application Publication
(10) Pub. No.: US 2013/0173136 A1
(43) Pub. Date: Jul. 4, 2013

(54) APPARATUS AND METHOD FOR DISPLAYING VEHICLE-DRIVING INFORMATION IN MOBILE TERMINAL

(71) Applicant: Samsung Electronics Co., Ltd., Gyeonggi-do (KR)

(72) Inventors: Young-Chool KIM, Seoul (KR); Hyun-Wook Cho, Gyeonggi-do (KR); Na-Ri Kim, Gyeonggi-do (KR); Jong-Woo Park, Seoul (KR)

(73) Assignee: Samsung Electronics Co., Ltd., Gyeonggi-do (KR)

(21) Appl. No.: 13/734,530

(22) Filed: Jan. 4, 2013

(30) Foreign Application Priority Data
Jan. 4, 2012 (KR) 10-2012-0000923
Mar. 30, 2012 (KR) 10-2012-0032885

(51) Int. Cl. B60Q 1/00

(52) U.S. Cl. CPC B60Q 1/00
USPC 701/101; 340/439

(57) ABSTRACT

An apparatus for displaying vehicle-driving information in a mobile terminal is provided. The apparatus includes an input/output unit for receiving information about a vehicle; a calculator for calculating an average of driving histories of the vehicle in units of predetermined time based on the received information; and a display for displaying the calculated average.

### PRIORITY

This application claims priority under 35 U.S.C. §119(a) to a Korean Patent Application filed in the Korean Intellectual Property Office on Jan. 4, 2012 and assigned Serial No. 10-2012-0000923, and a Korean Patent Application filed in Korean Intellectual Property Office on Mar. 30, 2012 and assigned Serial No. 10-2012-0032885, the entire disclosures of which are incorporated herein by reference.

### BACKGROUND OF THE INVENTION

1. Field of the Invention

The present invention relates generally to a mobile terminal, and more particularly, to a vehicle-driving information display apparatus and method for displaying a vehicle's driving history on a daily and monthly basis in a mobile terminal.

2. Description of the Related Art

On-Board Diagnosis (OBD) is a system that turns on a Malfunction Indication Lamp (MIL) on a dashboard in case there are problems with a vehicle, allowing the driver to have the vehicle checked for problems.

OBD may be classified into OBD-I and OBD-II.

OBD-I detects failures due to the disconnection or short-circuit of various input/output sensors connected to an Engine Control Module (ECM), and OBD-II diagnoses performance of sensors, which are not disconnected/short-circuited, and also diagnoses if the system is operating normally.

OBD is mounted in a front dashboard of vehicles. As OBD is mounted in a vehicle in this way, the vehicle performs self-diagnosis. Additionally, OBD may obtain vehicle information from an ECM of the vehicle. The vehicle information includes information about the vehicle, such as gas mileage, Revolutions Per Minute (RPM), speed, and vehicle condition.

This information may be transmitted to smart phones. The term “smart phone” refers to a terminal having the combined advantages of mobile communication terminals (including Personal Communications Service (PCS) terminals and Personal Digital Assistants (PDAs)), a terminal having the integrated features of voice call-related functions of the mobile communication terminals and the data communication functions such as schedule management, faxing, and Internet access. This smart phone will be referred to herein as a “mobile terminal.”

OBD transmits vehicle information to a mobile terminal, and the mobile terminal displays the vehicle's gas mileage history in the vehicle information received from the OBD on a daily basis or in response to an event in the form of a list.

Since the gas mileage information is provided in the form of a list, the user inconveniently searches through his driving history on a specific day from the list in sequence, and may have a difficulty identifying a certain periodic phenomenon that occurs repeatedly on a daily basis and/or weekly basis.

### SUMMARY OF THE INVENTION

Accordingly, the present invention has been made to solve the above-stated problems occurring in the prior art, and an aspect of the present invention provides a vehicle-driving information display apparatus and method for displaying vehicle's driving histories on a daily basis and a monthly basis in a mobile terminal.

In accordance with one aspect of the present invention, an apparatus for displaying vehicle-driving information in a mobile terminal is provided. The apparatus includes an input/output unit for receiving information about a vehicle; a calculator for calculating an average of driving histories of the vehicle in units of predetermined time based on the received information; and a display for displaying the calculated average.

In accordance with another aspect of the present invention, a method for displaying vehicle-driving information in a mobile terminal is provided. The method includes receiving information about a vehicle; calculating an average of driving histories of the vehicle in units of predetermined time based on the received information; and displaying the calculated average.

### BRIEF DESCRIPTION OF THE DRAWINGS

The above and other aspects, features and advantages of certain embodiments of the present invention will be more apparent from the following description taken in conjunction with the accompanying drawings, in which:

FIG. 1 is a block diagram illustrating a vehicle-driving information display apparatus in a mobile terminal according to an embodiment of the present invention;

FIG. 2 is a flowchart illustrating a method for synchronizing driving history information in a mobile terminal according to an embodiment of the present invention;

FIG. 3 illustrates driving history information displayed in the form of a calendar according to an embodiment of the present invention; and

FIG. 4 is a flowchart illustrating a method for displaying vehicle-driving information in a mobile terminal according to an embodiment of the present invention.

### DETAILED DESCRIPTION OF EMBODIMENTS OF THE PRESENT INVENTION

Embodiments of the present invention will now be described in detail with reference to the accompanying drawings. Throughout the drawings, the same drawing reference numerals will be understood to refer to the same elements, features and structures. In the following description, descriptions of well-known functions and constructions are omitted for clarity and conciseness.

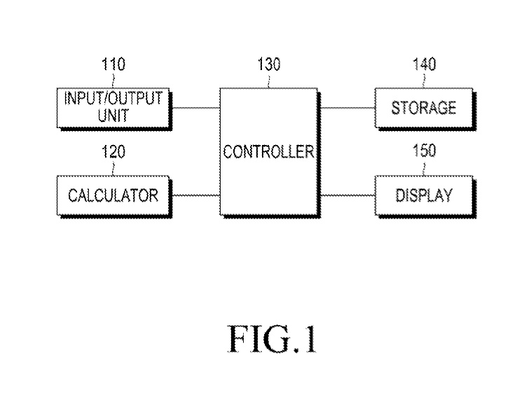

FIG. 1 is a block diagram illustrating a vehicle-driving information display apparatus in a mobile terminal according to an embodiment of the present invention.

The vehicle-driving information display apparatus includes an input/output unit 110 for receiving and outputting the vehicle's driving information by communicating with an On-Board Diagnosis (OBD), a calculator 120 for averaging driving histories on a daily basis, a weekly basis and a monthly basis based on received driving information, a storage 140 for storing the received driving information and the calculated average, and a display 150 for displaying the calculated average on a daily basis, a weekly basis and a monthly basis.

The vehicle-driving information display apparatus according to an embodiment of the present invention will now be described in detail below with reference to FIG. 1.

The input/output unit 110 receives and outputs information about a vehicle by communicating with an OBD mounted inside or outside the vehicle. The information includes information indicating problems with the vehicle, and driving history-related information such as RPM, speed, and gas mileage. The input/output unit 110 inputting/outputting this information performs communication with the OBD through a wireless protocol or an external interface. The input/output unit 110 transmits/receives first and/or second vehicle information, and has at least one built-in communication module.

The calculator 120 calculates driving history information received through the input/output unit 110. The calculator 120 averages the vehicle's driving histories on a daily basis, a weekly basis, a monthly basis and a yearly basis. The calculator 120 calculates an average of the vehicle's gas mileage, RPM, instantaneous gas mileage, fuel efficiency, average/maximum speed, fuel consumption, driving time, CO₂ emission, efficiency index, and the like on an hourly basis, a daily basis, a weekly basis and a monthly basis. The calculator 120 calculates an efficiency index based on the vehicle's fuel efficiency. The efficiency index, an index determined to include driver's driving habit factors, is divided into a plurality of ranks as shown in Table 1 below. Although only the efficiency index is described in Table 1, it is apparent that corresponding tables are available for a vehicle's gas mileage, RPM, instantaneous gas mileage, fuel efficiency, average/maximum speed, fuel consumption, driving time, CO₂ emission, and the like, and an average thereof may be calculated on an hourly basis, a daily basis, weekly basis and monthly basis.

TABLE 1

| Rank | Calculated OBD value | Efficiency index |
|---|---|---|
| 1 | 101-200 | Excellent |
| 2 | 81-100 | Good |
| 3 | 51-80 | Normal |
| 4 | 31-50 | Poor |
| 5 | 0-30 | Very poor |

As shown in Table 1, a calculated OBD value of 101 to 200 corresponds to the highest rank and represents excellent fuel efficiency. A calculated OBD value of 81 to 100 corresponds to a rank that is lower by one level than the highest rank, and represents good fuel efficiency. A calculated OBD value of 51 to 80 corresponds to an intermediate rank and represents normal fuel efficiency. A calculated OBD value of 31 to 50 corresponds to a low rank and represents poor fuel efficiency. And finally, a calculated OBD value of 0 to 30 corresponds to the lowest rank and represents very poor fuel efficiency. This efficiency index is calculated based on a gas mileage index and a habit index. In other words, the efficiency index is calculated by subtracting the habit index from the gas mileage index. The gas mileage index is calculated by dividing the current driving gas mileage by a certified gas mileage that was input during vehicle registration, and the habit index is calculated by dividing a sum of the number of sudden accelerations and the number of sudden decelerations by a driving distance. For example, the sudden acceleration may correspond to the sudden increase of the speed due to the user's sudden step on the accelerator pedal, while the sudden deceleration may refer to the sudden decrease of the speed due to the user's sudden step on the brake pedal while driving. These sudden acceleration and sudden deceleration may be determined by calculating a vehicle speed variation of Vt1−Vt0 in a predetermined time period of t0 to t1, and comparing the calculated value with a predetermined threshold or range. Specifically, the sudden acceleration may be detected when the calculated value is greater than the predetermined threshold or range, while the sudden deceleration may be detected when the calculated value is less than or equal to the predetermined threshold or range. This efficiency index may range from a maximum of 200 to a minimum of 0.

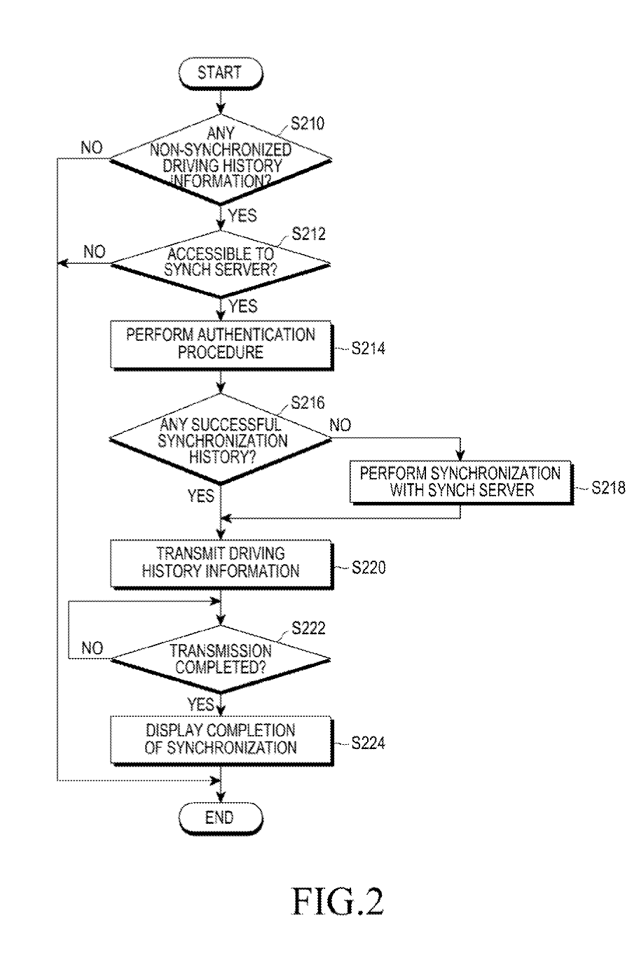

The controller 130 controls the overall operation of the vehicle-driving information display apparatus. The controller 130 distinguishes each of at least two ranks including a rank corresponding to the calculated average. These ranks are the vehicle's efficiency ranks, and are determined by subtracting the habit index obtained by dividing a sum of the number of sudden accelerations and the number of sudden decelerations by the driving distance, from the gas mileage index obtained by dividing the vehicle's average gas mileage for the current driving by the vehicle's certified gas mileage. The vehicle's efficiency ranks (Er=Gm−Hi) are determined by subtracting the habit index (Hi) from the gas mileage (Gm). The gas mileage (Gm=AvGm/VC) is determined by dividing the vehicle's average gas mileage (AvGm) for the current driving by the vehicle's certified (VC). And, the habit index (Hi=(NA+ND)/DD) is determined by dividing a sum (NA+ND) of the number (NA) of sudden accelerations and the number of sudden decelerations (ND) by the driving distance (DD). Furthermore, each index (e.g., efficiency index is divided into five levels (Rank 1 to 5)). The controller 130 distinguishes each of the at least two ranks by differentiating a color, a marking pattern, and rank indication thereof, and displays on the display 150 the color, marking pattern and rank indication, which are applied to the rank corresponding to the calculated average. The controller 130 stores the values calculated by the calculator 120, in a synchronization server. When stored in the synchronization server, the calculated values are transmitted through an application installed in the mobile terminal. When a driver wants to see the stored values on another mobile terminal, the driver then accesses the synchronization server through an authentication procedure and downloads desired values. A process of performing synchronization by transmitting the driving history information to the synchronization server will be described below with reference to FIG. 2. The controller 130 transmits the average calculated by the calculator 120 to the synchronization server, or receives an average from the synchronization server through an application installed in the mobile terminal and stores the received average.

Upon detecting a connection to the ECM built in the vehicle by means of a detector (not shown), the controller 130 determines whether the OBD is mounted and the vehicle is the same vehicle, by comparing vehicle information (hereinafter referred to as ‘first vehicle information’) being input through the input/output unit 110 with the vehicle information (hereinafter referred to as ‘second vehicle information’) stored in advance. The detector (not shown) is a module for detecting a connection to the ECM built in the vehicle through the input/output unit 110. The detector may be provided separately, or may be incorporated into the controller 130. The second vehicle information is stored in advance in the storage 140, and may include not only unique identifiers of all vehicles in which the OBD is mounted, but also a unique identifier of the vehicle in which the OBD is most recently mounted. The controller 130 compares the first and second vehicle information, and if they are the same, determines that the vehicle in which the OBD is most recently mounted is the same as the vehicle in which the OBD is currently mounted. Specifically, the controller 130 compares the unique identifier of the vehicle in which the OBD is currently mounted, with the unique identifier, which is stored in advance, of the vehicle in which the OBD is most recently mounted, and if they are the same, the controller 130 determines that they are the same vehicles. Thereafter, the controller 130 receives vehicle information from the vehicle in which the OBD is currently mounted, and updates the vehicle information stored in advance in the storage 140 with the received vehicle information.

The controller 130 compares the unique identifier of the vehicle in which the OBD is currently mounted, with the unique identifier, which is stored in advance, of the vehicle in which the OBD is most recently mounted, and if they are not the same, the controller 130 determines that the OBD is mounted in a new vehicle and the vehicle is a new vehicle. The controller 130 receives vehicle information from the new vehicle and stores the received vehicle information. Otherwise, the controller 130 updates the vehicle information stored in the storage 140 with the vehicle information received from the new vehicle. If there is no vehicle information stored in advance in the storage 140, the controller 130 determines that the OBD is newly mounted.

The storage 140 stores the received information and the calculated average. The storage 140 stores a table representing a rank of the fuel efficiency. Table 1 above is a table for informing the driver of a rank corresponding to the gas mileage calculated by the calculator 120. Different tables are stored for different driving history information, and in each table, different ranks are assigned different colors.

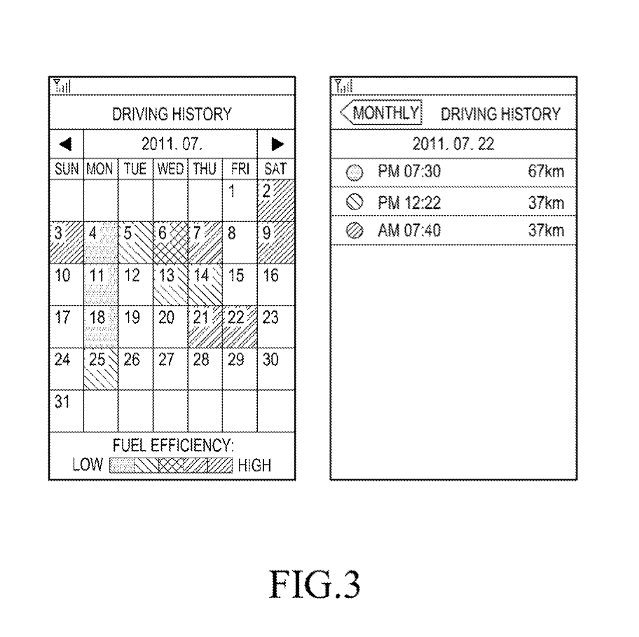

The display 150 displays the average of driving histories, calculated by the calculator 120, in the form of a calendar on a daily basis, a weekly basis, a monthly basis, and a yearly basis. If a rank corresponding to the calculated average is selected, the display 150 displays the vehicle's driving history. The vehicle information received through the input/output unit 110 is provided from the OBD mounted in the vehicle, and includes information about at least one of the vehicle's gas mileage, RPM, instantaneous gas mileage, fuel efficiency, speed, fuel consumption, driving time, CO₂ emission, and vehicle condition. The vehicle's driving history includes at least one of the vehicle's gas mileage, RPM, speed, fuel consumption, and driving time. The calculated vehicle's gas mileage, RPM, instantaneous gas mileage, fuel efficiency, average/maximum speed, fuel consumption, driving time, and CO₂ emission are displayed in the form of a calendar by differentiating colors thereof. A detailed description thereof will be made with reference to FIG. 3.

FIG. 2 is a flowchart illustrating a method for synchronizing driving history information in a mobile terminal according to an embodiment of the present invention.

A method for synchronizing driving history information according to an embodiment of the present invention will be described in detail below with reference to FIG. 2.

The mobile terminal checks in step S210 whether there is any driving history information that is not synchronized with the information in a synchronization server. The mobile terminal, which has at least one installed application, transmits driving history information to the synchronization server through the application, or through other communication protocols or modules. After the driving history information is transmitted to the synchronization server, the mobile terminal recognizes the transmission, and if driving history information is newly generated, the mobile terminal recognizes the new generation as well.

If there is driving history information in step S210, in order to transmit the driving history information, the mobile terminal checks in step S212 whether it can access the synchronization server, and if it can, the mobile terminal performs an authentication procedure with the synchronization server in step S214. The mobile terminal accesses the synchronization server using an application installed on the mobile terminal or uses a separate communication protocol. Upon accessing the synchronization server, the mobile terminal performs an authentication procedure with the synchronization server using its unique information.

The mobile terminal checks in step S216 whether there have been successful synchronizations in the past with the synchronization server. The mobile terminal records the number of times it has accessed the synchronization server, an access time, and the like. Based on these records, the mobile terminal checks whether there have been successful synchronizations based on the access time of recent successful synchronizations.

If there have been no recent successful synchronizations in step S216, the mobile terminal performs synchronization with the synchronization server in step S218, and transmits the vehicle's driving history information in step S220. The driving history information is automatically transmitted if the driving history is generated or updated, or a predetermined time has elapsed.

If there is successful synchronization history in step S216, the mobile terminal transmits the driving history information to the synchronization server in step S220. The driving history information is transmitted through an application installed in the mobile terminal or through a separate communication protocol.

If the transmission is completed in step S222, the mobile terminal displays a notification message indicating the completion of a synchronization procedure with the synchronization server in step S224. The synchronization procedure, in which the mobile terminal transmits its driving history to the synchronization server, is performed when the driving history information is generated or updated. This driving history information is automatically transmitted upon a lapse of a predetermined time.

FIG. 3 illustrates driving history information displayed in the form of a calendar according to an embodiment of the present invention.

The left drawing in FIG. 3 illustrates driving history information for July 2011, which is displayed on a daily basis, and the right drawing illustrates the displayed times and distances the driver drove his or her vehicle on a specific date, for example, July 22. The dates, on which the driver drove his or her vehicle in July, correspond to the marked dates of 2 to 7, 9, 11, 13, 14, 18, 21, 22, and 25. The marked dates are distinguished based on their fuel efficiency. Although the marked dates are distinguished in various different ways of including color, marking pattern, rank indication, and the like, the marked dates will be distinguished by marking them differently according to their fuel efficiency for convenience purpose only. For example, the fuel efficiency was the lowest on the dates of 4, 11 and 18, was the next lowest on the dates of 5, 13, 14 and 25, was normal on the date of 6, was higher than normal on the dates of 7, 21 and 22, and was the highest on the dates of 2, 3 and 9. The driver didn't drive the vehicle on the non-marked days.

When the vehicle has been driven in this way, the mobile terminal receives driving history information from OBD and calculate an average of the received driving history information on a daily basis, making it possible to display the fuel efficiency on a daily basis. Although the fuel efficiency is shown on a daily basis for a specific month in FIG. 3, it is an example and the average may be calculated and displayed on an hourly basis, a weekly basis, a monthly basis, and a yearly basis.

As shown in the right drawing, the driver drove the vehicle 37 Km with the highest fuel efficiency starting at 7:40 a.m., drove the vehicle 37 Km with low fuel efficiency starting at 12:22 p.m., and drove the vehicle 67 Km with the lowest fuel efficiency starting at 7:30 p.m.

If the driver drove the vehicle several times on a certain date in this way, the mobile terminal calculates daily fuel efficiency by calculating the driving distance per gallon by means of OBD.

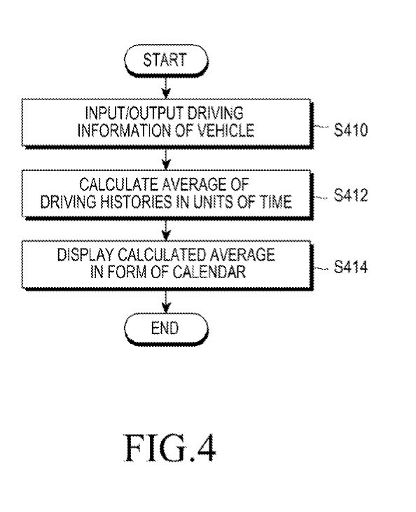

FIG. 4 is a flowchart illustrating a method for displaying vehicle-driving information in a mobile terminal according to an embodiment of the present invention.

Referring to FIG. 4, the mobile terminal receives and outputs the vehicle's driving information from/to OBD mounted in the vehicle in step S410. An external interface for data transmission/reception is mounted between the mobile terminal and the OBD. The mobile terminal may receive and output the stored vehicle's driving information from/to the OBD through the external interface. The driving information includes information indicating abnormality of the vehicle, and driving history-related information such as RPM, speed, and gas mileage.

In step S412, the mobile terminal calculates an average of driving histories in units of a predetermined time. Based on the received vehicle's driving information, the mobile terminal calculates an average of the gas mileage on an hourly basis, a daily basis, a weekly basis, a monthly basis, or a yearly basis. In addition, the mobile terminal calculates an average of the vehicle's gas mileage, RPM, instantaneous gas mileage, fuel efficiency, average/maximum speed, fuel consumption, driving time, CO₂ emission, efficiency index, and the like on an hourly basis, a daily basis, a monthly basis, or a yearly basis. The mobile terminal calculates an efficiency index based on the fuel efficiency. The mobile terminal calculates an efficiency index that can be ranked, even for the vehicle's gas mileage, RPM, instantaneous gas mileage, fuel efficiency, average/maximum speed, fuel consumption, driving time, and CO₂ emission. An average of not only the fuel efficiency but also the gas mileage, RPM, instantaneous gas mileage, speed, fuel consumption, driving time, and CO₂ emission are calculated in units of a predetermined time.

In step S414, the mobile terminal displays the average calculated in step S412. The calculated average is displayed in the form of a calendar on a daily basis or a monthly basis. Dates corresponding to a specific month are distinguished by differentiating colors and marks thereof according to the ranks of the calculated averages. The ranks are classified into at least two different ranks. A display of the mobile terminal has a touch-screen feature, and if a specific date is selected, the display displays details of the selected date. The details may include the number of drives on a specific date, driving time of each driving, driving distance of each driving, and gas mileage of each driving.

Embodiments of the present invention may be implemented in hardware, software, or a combination of the hardware and the software. The software may be optically or magnetically recorded in a volatile or non-volatile storage (e.g., Read Only Memory (ROM)), a memory (e.g., Random Access Memory (RAM), memory chip, and Integrated Circuit (IC)), or an optomagnetic device (e.g., Compact Disc (CD), Digital Versatile Disc (DVD), magnetic disc, and magnetic tape), no matter whether they are erasable or rewritable, and may be stored in a machine-readable storage medium. A memory mountable in a mobile terminal may be an example of a storage medium capable of storing a program or programs including instructions to implement embodiments of the present invention and of being readable by an appropriate machine. Therefore, the present invention includes programs having codes for implementing the apparatus and method as set forth in claims of the specification, and a storage medium capable of storing the programs and being readable by a machine (computer, etc.). In addition, these programs may be electronically transferred on an arbitrary medium such as a communication signal delivered through wire/wireless connection, and the present invention may include equivalents thereof.

While the invention has been shown and described with reference to certain embodiments thereof, it will be understood by those skilled in the art that various changes in form and details may be made therein without departing from the spirit and scope of the invention as defined by the appended claims and their equivalents.

What is claimed is:

1. An apparatus for displaying vehicle-driving information in a mobile terminal, the apparatus comprising:
an input/output unit for receiving information about a vehicle;
a calculator for calculating an average of driving histories of the vehicle in units of predetermined time based on the received information; and
a display for displaying the calculated average.

2. The apparatus of claim 1, further comprising:
a controller for distinguishing between at least two ranks corresponding to the calculated average.

3. The apparatus of claim 2, wherein the controller distinguishes between the at least two ranks by differentiating a color, a marking pattern, and a rank indication of the at least two ranks.

4. The apparatus of claim 2, wherein the controller displays, on the display, a color, a marking pattern and a rank indication applied to the rank corresponding to the calculated average.

5. The apparatus of claim 1, further comprising:
a storage for storing the received information and the calculated average.

6. The apparatus of claim 1, wherein the calculator calculates an average of the driving histories on a daily basis, a weekly basis, a monthly basis, and a yearly basis.

7. The apparatus of claim 1, wherein if a rank corresponding to the calculated average is selected, the display displays a detailed driving history of the vehicle, corresponding to the selected rank.

8. The apparatus of claim 1, wherein the information is provided from an On-Board Diagnosis (OBD) mounted in the vehicle, and includes information about at least one of a vehicle's gas mileage, Revolutions Per Minute (RPM), instantaneous gas mileage, fuel efficiency, speed, fuel consumption, driving time, CO₂ emission, and vehicle condition.

9. The apparatus of claim 1, wherein the driving history includes at least one of the vehicle's gas mileage, RPM, speed, fuel consumption, and driving time.

10. The apparatus of claim 4, wherein the controller transmits the calculated average to a server, or receives an average from the server through an application installed in the mobile terminal, and stores the received average.

11. The apparatus of claim 2, wherein the rank is an efficiency rank of the vehicle, and is determined by subtracting a habit index obtained by dividing a sum of the number of sudden accelerations and the number of sudden decelerations by a driving distance, from a gas mileage index obtained by dividing an average gas mileage of the vehicle for current driving by a certified gas mileage of the vehicle.

12. A method for displaying vehicle-driving information in a mobile terminal, the method comprising:
receiving information about a vehicle;
calculating an average of driving histories of the vehicle in units of predetermined time based on the received information; and
displaying the calculated average.

13. The method of claim 12, further comprising:
distinguishing between at least two ranks including a rank corresponding to the calculated average by differentiating a color, a marking pattern, and rank indication thereof.

14. The method of claim 12, wherein displaying the calculated average comprises displaying a color, a marking pattern and rank indication applied to the rank corresponding to the calculated average.

15. The method of claim 12, further comprising:
storing the received information and the calculated average.

16. The method of claim 12, wherein calculating the average comprises calculating an average of the driving histories on a daily basis, a weekly basis, a monthly basis, and a yearly basis.

17. The method of claim 12, wherein displaying comprises:
if a rank corresponding to the calculated average is selected, displaying a detailed driving history of the vehicle, corresponding to the selected rank.

18. The method of claim 12, wherein the information is provided from an On-Board Diagnosis (OBD) mounted in the vehicle, and includes information about at least one of the vehicle's gas mileage, Revolutions Per Minute (RPM), instantaneous gas mileage, fuel efficiency, speed, fuel consumption, driving time, CO₂ emission, and vehicle condition.

19. The method of claim 12, wherein the driving history includes at least one of the vehicle's gas mileage, RPM, speed, fuel consumption, and driving time.

20. The method of claim 13, wherein the rank is an efficiency rank of the vehicle determined by subtracting a habit index obtained by dividing a sum of the number of sudden accelerations and the number of sudden decelerations by a driving distance, from a gas mileage index obtained by dividing an average gas mileage of the vehicle for current driving by a certified gas mileage of the vehicle.
